(19) United States
(12) Patent Application Publication
(10) Pub. No.: US 2011/0107938 A1
(43) Pub. Date: May 12, 2011

(54) METHOD AND TRANSFER TERMINAL FOR TRANSFERRING SEMI-TRAILERS FROM RAILWAY TO ROADWAY, AND VICE VERSA AND FOR TRANSPORTING SEMI-TRAILERS BY RAIL, AS WELL AS TRACTION VEHICLE FOR SEMI-TRAILERS AND TRACTOR TRAILER UNIT

(75) Inventors: Hans-Jürgen Weidemann, Speyer (DE); Michael Baier, Mannheim (DE); Fritz Merk, Landshut (DE)

(73) Assignee: CARGOBEAMER AG, Bautzen (DE)

(21) Appl. No.: 12/915,620

(22) Filed: Oct. 29, 2010

(30) Foreign Application Priority Data
Nov. 9, 2009 (DE) 10 2009 052 382.0

(51) Int. Cl. B61B 1/00; B62D 1/24; B62D 63/02; B65G 67/02; B62D 53/04; B61K 13/00

(52) U.S. Cl. 104/29; 180/167; 414/333; 180/14.1; 414/809

(57) ABSTRACT

The invention relates to a traction vehicle (21) for semi-trailers (3), preferably for loading and unloading the semi-trailers (3) onto and off of a freight train (18), in particular, as part of the rolling highway, wherein the freight train (18) comprises several freight cars coupled to one another, in particular low-floor railcars (10), and a continuous driving lane in the longitudinal direction (20) of the train for moving the semi-trailers (3) on the freight train (18), wherein the traction vehicle (21) is unmanned and self-propelled, as well as a tractor-trailer unit (30) formed from the traction vehicle (21) and a semi-trailer (3), a method for transferring semi-trailers (3) from the railway (12) to the roadway and vice versa, as well as a freight transfer terminal thereto, and a method for transferring semi-trailers (3) from the railway (12) to the roadway and vice versa and for transporting the semi-trailers (3) on the railway (12).

### CROSS-REFERENCE TO RELATED APPLICATIONS

This application claims priority to German Patent Application No. 10 2009 052 382.0, filed Nov. 9, 2009, entitled “METHOD AND FREIGHT TRANSFER TERMINAL FOR TRANSFERRING SEMI-TRAILERS FROM RAILWAY TO ROADWAY, AS WELL AS TRACTION VEHICLE FOR SEMI-TRAILERS AND TRACTOR TRAILER UNITS THERETO, AS WELL AS METHOD FOR TRANSFERRING SEMI-TRAILERS FROM RAILWAY TO ROADWAY AND VICE VERSA AND FOR TRANSPORTING SEMI-TRAILERS BY RAIL” the entire contents of which are incorporated herein by reference.

### FIELD OF THE INVENTION

The present invention relates to a method for transferring semi-trailers from railway to roadway and vice versa, as well as a freight transfer terminal and a traction vehicle for semi-trailers. The present invention further relates to a tractor-trailer unit formed from the traction vehicle and a semi-trailer, and a method for transferring semi-trailers from railway to roadway and vice versa, and for transporting semi-trailers by rail.

### BACKGROUND AND BRIEF SUMMARY OF THE INVENTION

In combined roadway-railway transportation, the freight to be transported is conveyed in containers, swap containers or semi-trailers, partially by means of special freight trains and partially by road. There is a distinction between unaccompanied and accompanied combined transportation. In unaccompanied or non-accompanied transportation, the freight is transferred without accompanying motor vehicles. Semi-trailers are uncoupled from the tractors, loaded onto the freight-train car without them and transported. The freight train is loaded and unloaded in part by means of cranes and in part by means of transverse loading. Such a method by means of transverse loading is known from EP 1993894 A1, for example.

In accompanied transport, for example, the so-called rolling highway, complete trucks, particularly semi-trailer trucks consisting of a tractor and a semi-trailer are driven one after the other in the longitudinal direction of the train onto and off of the train cars. The freight cars in this case are low-floor railcars that form a continuous driving lane across the entire train. Low-floor railcars have very small wheel diameters of, for example, 380 mm, 360 mm or 335 mm in order to guarantee that the trucks can be carried low enough to maintain the mandatory clearance profile. The drivers travel along with the semi-trailer trucks and are housed during the train trip in additionally connected accompanying cars.

The advantage of the rolling highway is that the drivers can maintain the legally prescribed rest periods without having to interrupt freight transport. Because the tractors are carried along with the semi-trailers, however, a large amount of dead weight relative to the freight load is transported. Moreover, the tractors are not available to the shipper for other use.

Accordingly, embodiments of the present invention provide a method and a freight transfer unit for transferring semi-trailers from roadway to railway and vice versa that is cost effective and saves time, wherein the freight train comprises freight cars, in particular, low-floor railcars that form a continuous driving lane across the entire freight train for moving the semi-trailers on the freight train.

Also provided are an assistance means as well as a unit for cost effective and time-saving transferring of semi-trailers.

In addition, a cost-effective and time-saving method for transferring semi-trailers from the roadway to a freight train and vice versa and for transporting semi-trailers by rail is to be provided.

Advantageous embodiments are characterized in the respective appended subordinate claims.

### BRIEF DESCRIPTION OF THE DRAWINGS

The invention will be described below in detail for the sake of example with reference to a drawing. therein:

FIG. 1 shows a schematic side view of a semi-trailer truck;

FIG. 2 shows a schematic side view of a semi-trailer without a tractor;

FIG. 3 shows a schematic side view of a low-floor railcar;

FIG. 4 shows a schematic side view of an unmanned, self-propelled traction vehicle according to the invention;

FIG. 5 shows a schematic side view of a semi-trailer coupled to an unmanned, self-propelled traction vehicle according to the invention;

FIGS. 6a-c show schematic side views of an unmanned, self-propelled tractor-trailer unit driving onto a low-floor railcar; and

FIG. 7 shows a schematic side view of a freight train onto which several tractor-trailer units are driven one after the other.

### DETAILED DESCRIPTION OF THE INVENTION

A semi-trailer truck or a tractor-trailer vehicle 1 (FIG. 1) has a tractor 2 (also referred to herein as a truck tractor) and a semi-trailer3 (also referred to herein as a truck-trailer or trailer) coupled to it. The tractor 2 has a driver's cabin 4, a steering and drive axle, an engine and transmission as well as a fifth wheel coupling for attaching and coupling a semi-trailer 3.

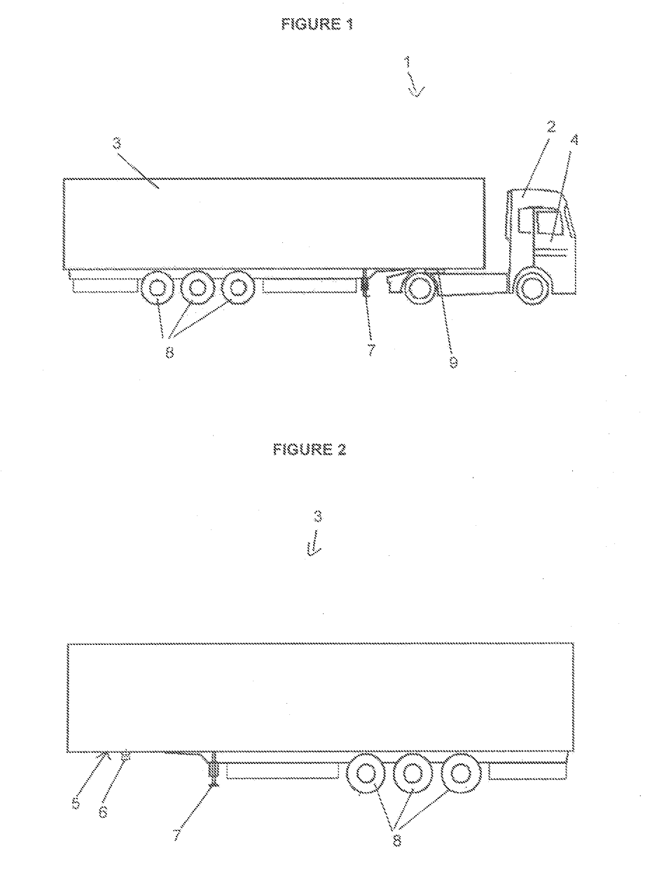

The semi-trailer 3 (FIG. 2) has a horizontal trailer support surface 5 and a standardized kingpin 6 projecting vertically downward from the trailer support 5 that is fixedly connected to the trailer support surface 5. In addition, the semi-trailer 3 has extendable conventional support legs 7 that serve to support the semi-trailer 3 on the ground when it is uncoupled from the tractor 2. The semi-trailer 3 has wheels 8 at its rear end. Starting from the trailer support surface 5, the standardized kingpin 6 has a first cylindrical circumferential surface and a second cylindrical circumferential surface, between which a circumferential groove is provided. For coupling the kingpin 6, the fifth wheel coupling of the tractor 2 has a conventional semi-trailer plate 9, having a central introduction opening, for supporting the trailer support surface 5 and for introducing or holding the kingpin 6, as well as a rotary catch mechanism for fixing the kingpin 6.

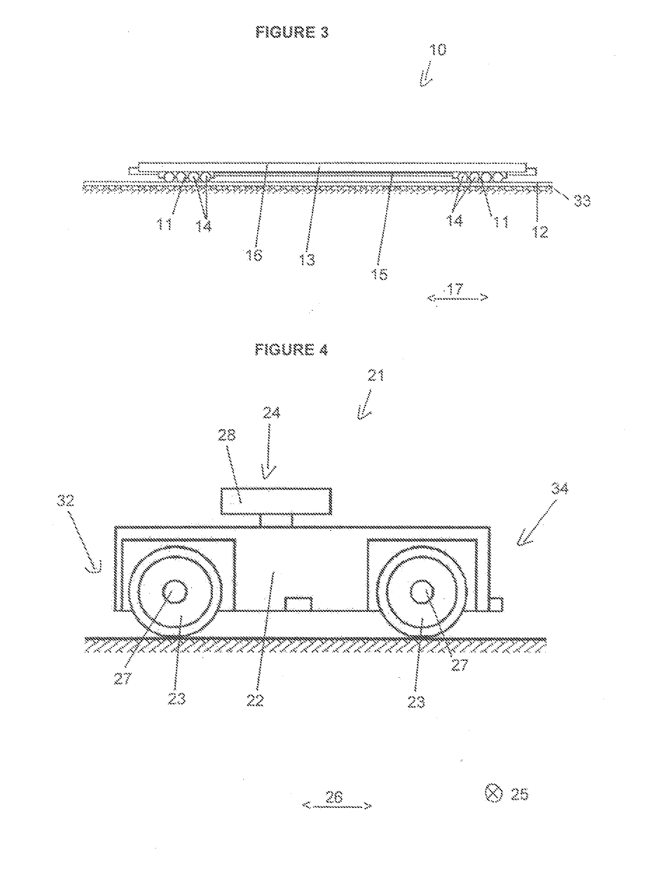

A conventional low-floor car or low-floor railcar 10 (FIGS. 3, 6, 7) is a freight car or freight railcar onto which the semi-trailer trucks 1 can drive directly. A low-floor railcar 10 preferably has two wheel trucks 11 for moving the low-floor railcar 10 on rails 12 of the track 33, as well as a railcar frame 13. The wheel trucks 11 preferably have several axles and have several sequentially arranged wheelsets with two wheels 14 each. The wheels 14 have a small diameter, preferably in the range of 300 to 400 mm. The tub-like railcar frame 13 has a bottom wall 15 as well as two lateral sidewalls 16 projecting obliquely upwards from the bottom wall 15. The tub-like railcar frame 13 also has a longitudinal extension in a longitudinal direction 17 of the railcar. The railcar bottom wall 15 additionally has an upper loading surface which can be driven on, with two parallel driving tracks. The railcar frame 13 is open to the front and the back, so that a semi-trailer truck 1 can drive onto it and leave it in the longitudinal direction 17 of the railcar.

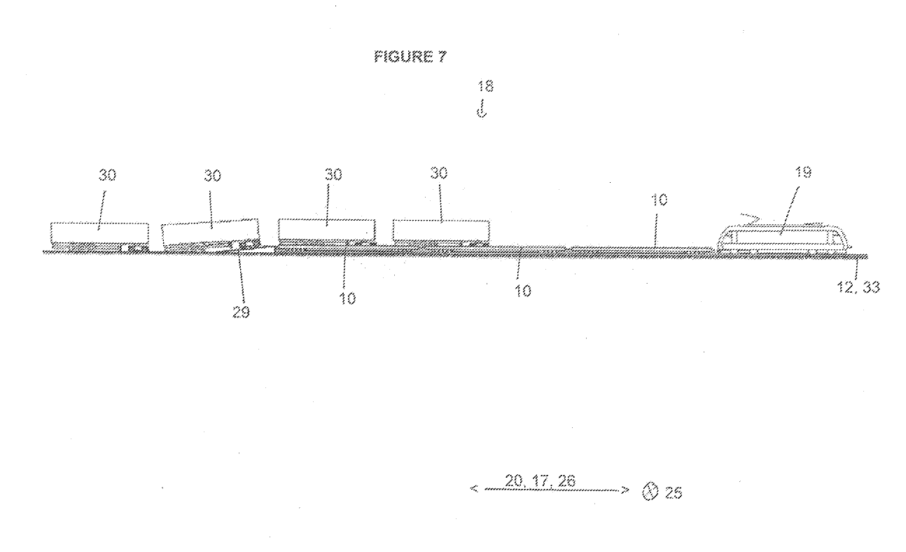

A freight train 18 (FIG. 7) has a locomotive 19 and several low freight cars, in particular, low-floor railcars 10 arranged one after another in a longitudinal direction 20 of the train and coupled to one another. The freight train 18 additionally has a continuous or continuously drivable driving lane in the longitudinal direction 20 of the train with two continous driving tracks. The driving lane is formed by loading surfaces of the successively arranged low-floor railcars 10, and preferably by bridges that can be driven over and that are expediently arranged between each two low-floor railcars 10. If the distances between the individual low-floor railcars 10 are so small that the gaps between the low-floor railcars 10 can be driven over without problems, the bridges can be omitted. Due to the small diameter of the wheels 14, the driving tracks preferably have a low height of 270 to 400 mm, preferably 270 to 320 mm, measured from the top of the rail (TOR).

The traction vehicle 21 according to one embodiment of the invention (FIGS. 4-7) has a vehicle frame 22, expediently four wheels 23, drive means for driving or moving the traction vehicle 21, steering means for steering the traction vehicle 21, a fifth wheel coupling 24 for coupling a semi-trailer 3 as well as a control device and expediently a sensor unit with several sensors. According to the invention, the traction vehicle 21 is self propelled. That is to say, the traction vehicle 21 is an unmanned traction vehicle 21. Consequently the traction vehicle 21 has no driver's cab 4. The traction vehicle 21 can therefore preferably be moved unmanned soley. The traction vehicle 21 additionally has a front vehicle end 31 and a rear vehicle end 32.

The wheels 23 are, for example, known wheels of the type used for trucks. Two wheels 23 forming a wheelset are expediently arranged alongside one another in a horizontal transverse vehicle direction 25 and seated on the same wheel axis 27. The two wheelsets are arranged one after the other in a horizontal longitudinal vehicle direction 26 perpendicular to the transverse vehicle direction 25 (in and out of the page in FIG. 5). The wheels 23 each rotate about axes of rotation parallel to the transverse vehicle direction 25. Alternatively to the tandem axle embodiment, the wheels 23 can all be individually suspended. It also lies within the scope of the invention for the traction vehicle 21 to be configured as a tracked vehicle and to have two driven track chains as a propulsion means instead of the wheels 23.

Additionally, at least one of the two wheel axles 27 or at least one wheelset is steerable. Conventionally known steering means are used for steering. In particular, the traction vehicle 21 has a steering gear and a steering servomotor. The steering servomotor is advantageously driven electrically. For this purpose the traction vehicle 21 has a battery or storage battery or a fuel driven engine in combination with a generator or other energy storage device/generator for supplying the steering servomotor. The steering servomotor is additionally connected to a control unit, which will be discussed in detail below.

The drive means for driving the movable traction vehicle 21 have a drive motor as well as a gearbox for transferring the drive torque from the drive motor to the wheels 23, preferably to a wheelset. The drive motor is expediently driven electrically and supplied by means of the same battery as the steering servomotor. Alternatively, the drive motor can also be configured as an internal combustion engine, hybrid drive unit, fuel cell drive unit, hydraulic motor or with other motor principles. The drive motor is also connected to the control unit and can be controlled by means of the latter, which will likewise be discussed in detail below.

The fifth wheel coupling 24 (FIG. 4) has a conventional semi-trailer plate 28, expediently height-adjustable, for supporting the trailer support surface 5 of semi-trailer 5 as well as a rotary catch mechanism for enclosing and locking the kingpin 6. The trailer plate 28 has a V-shaped introduction slot for accommodating the kingpin 6. The rotary catch mechanism is arranged underneath the semi-trailer plate 28 and expediently mounted on the underside of the latter. The rotary catch mechanism additionally has a rotatably seated rotary catch with a cut out for accommodating the kingpin 6, which catch is pressed by means of a spring into its opened housing position. The rotary catch mechanism further comprises a rotatably seated, likewise spring-loaded locking lever which cooperates in a locking manner with the rotary catch in the closed position of the rotary catch mechanism. This is accomplished by engagement of the locking lever in a matching cutout of the rotary catch. The locking lever is connected to an unlocking handle, by means of which the locking lever can be actuated in such a manner that the locking of the rotary catch is released and thus the kingpin 6 is released. Alternatively, the locking lever or the unlocking handle can be driven automatically, e.g., via a servomotor that can be triggered by means of the control unit.

The traction vehicle 21 according to the invention is also preferably dimensioned such that it can drive under the front end of an uncoupled semi-trailer 6, i.e. into the area of the trailer support surface 5 and can preferably be arranged when driven straight aligned with it, as viewed in the vertical direction. That is to say, the traction vehicle 21 does not project laterally or frontwards from the semi-trailer 6 at all, or only to a slight extent. The mass of the traction vehicle 21 is also preferably dimensioned such that the traction vehicle 21 can pull or push a semi-trailer 21 without problems. In particular, the traction vehicle 21 has a mass of 2.0 to 7.0 tons, preferably 3.0 to 5.0 tons.

The control unit is used in particular for controlling the motion of the traction vehicle 21, i.e., the displacement of the traction vehicle 21. The control unit is consequently used for controlling the driving and the steering of the traction vehicle 21. The control unit also expediently serves to control additional elements of the traction vehicle 21, in combination with the sensor system and appropriate actuating members, e.g., servomotors or hydraulic units, for example.

For instance, the motion of the traction vehicle 21 is remote-controlled or partially remote-controlled. In particular, an automated interaction of the control unit on the traction vehicle 21 with a central control device set up outside the traction vehicles 21 is possible.

A communication of the control units arranged on the traction vehicles 21 with one another is likewise conceivable, so that the traction vehicles 21 can coordinate with one another. The remote-controlled movement of the traction vehicles 21 by human operating personnel is likewise possible.

For example, the external control device has one or more transmission/reception devices arranged outside of and remote from the traction vehicle 21, and the control unit of the traction vehicle 21 has a transmission/reception device arranged on the traction vehicle 21 for receiving and processing the signals arriving from the transmission device(s) and for driving the corresponding actuating members to execute the respective command.

The communication between the reception device(s) on the traction vehicles 21 and the control device can take place, for example, by means of radio transmission (e.g., WLAN, wireless local area networks) or other transmission means such as infrared. Alternatively, the evaluation of GPS (Global Positioning System) data can serve to detect the positions of the traction vehicles 21. The control unit in this case has a GPS data receiver.

Another possibility for identifying the positions of the traction vehicles 21 in the freight transport terminal and/or on the freight train 18 is controlling by means of orientation with respect to painted markings₅ present on the floor of the freight transport terminal and on the low-floor railcars 10. In this case the control unit has optical sensors for detecting painted markings.

Controlling can additionally be accomplished by means of orientation based on induction loops that are present on the floor of the freight transport terminal and on the low-floor railcars 10. In this case the control unit has, for example, magnetic/electrical sensors for identifying induction loops or other electromagnetically operating markings.

Other methods of location, for example radiolocation are also conceivable for detecting the position of the traction vehicles 21.

The transfer method or loading/unloading method according to the invention by means of the invented unmanned traction vehicles 21 will now be described further.

The manned semi-trailer trucks 1 to be transported arrive at a freight transfer terminal or freight transfer train station according to the invention. The semi-trailer trucks 1 are expediently parked by the drivers at predetermined positions in the freight transfer terminal and the semi-trailers 3 are uncoupled from the tractors 2. The support legs 7 are extended, preferably by an operator, e.g., the truck driver, so that the semi-trailers 3 rest on the support legs 7. The tractors 2 are driven away from the semi-trailers 3 by the drivers and can subsequently leave the freight transfer terminal or be coupled to arriving semi-trailers 3 and leave the freight transfer terminal with them.

Then the traction vehicles 21 according to the invention are coupled to the waiting uncoupled semi-trailers 3. For this purpose, a traction vehicle 21 drives up to each waiting semi-trailer 3. The height of the trailer plate 28 is adjusted if necessary and matched to the height of the trailer support surface 5 of the respective semi-trailer 3. This is done manually and mechanically by an operator, or by means of sensors on the traction vehicle 21 by which the height of the semi-trailer support surface 5 is measured, whereupon the control unit drives a corresponding actuation member to adjust the height of the trailer plate 28. Alternatively, the heights of the trailer support surface 5 of the semi-trailers 3 to be transferred are stored in a database so that the correct height of the trailer plates 28 can be adjusted based on this data by driving appropriate actuating means of the traction vehicle 21 by means of the control device.

For coupling, the respective traction vehicle 21 drives backwards under the trailer support surface 5 of the respective semi-trailer 3. In the process, the kingpin 6 moves into the introduction slot of the central plate 28 and into the opening of the rotary catch so that the latter is rotated in such a manner that it encloses the kingpin, particularly in the area of the circumferential groove. In this position the rotary catch is automatically locked by means of the locking lever using an interlocking mechanism. The trailer support surface 5 now rests on the trailer plate 28. Consequently the support legs 7 are again retracted, preferably by the operating personnel, especially by cranking. A semi-trailer 3 with a coupled traction vehicle 21 forms a respective unmanned movable tractor-trailer unit 30 (FIG. 5).

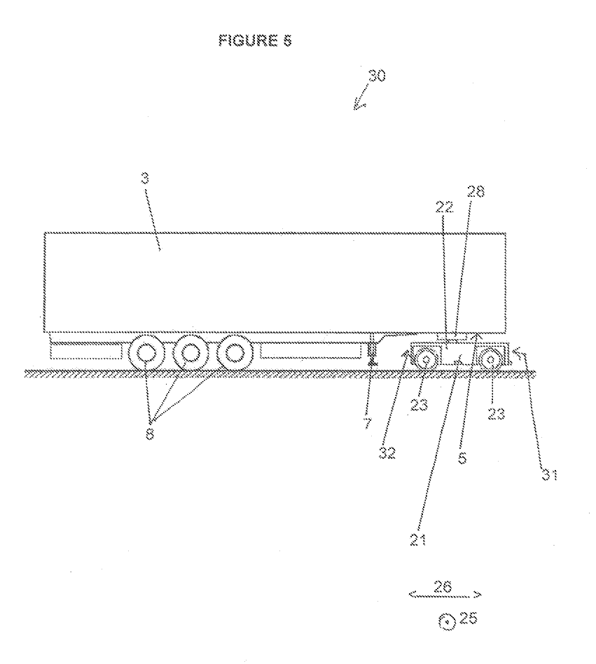

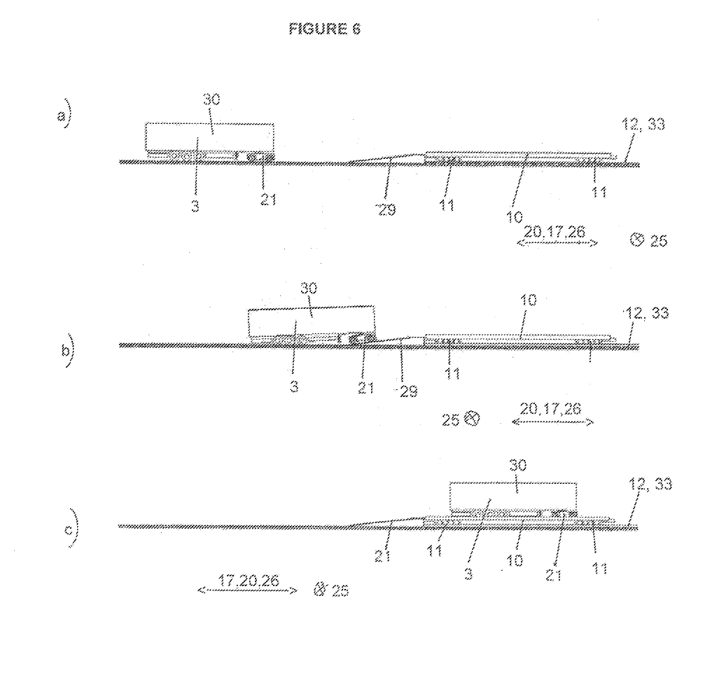

Now the semi-trailers 3 are driven onto a waiting freight train 18 in the longitudinal direction 20 of the train (FIGS. 6, 7). The freight train 18 is moved for this purpose with its rear end facing away from the locomotive 19 backwards to an entry and exit ramp 29 or an entry and exit bridge (not shown). Alternatively, the front end of the freight train 18 can be moved to such a ramp 29 by decoupling the locomotive 19 and pushing the freight train 18 by means of a shunting engine at the rear end of the train.

In addition, after appropriately blocking and securing the track section, a rotatable entry and exit bridge (not shown) can be pivoted over the track 33 so that the loading and unloading of the freight train 18 need not necessarily take place at the end of a track.

Alternatively a foldable entry ramp can be mounted on the first or last railcar (not shown).

The tractor-trailer units 30 consisting of the traction vehicle 21 and a coupled semi-trailer 3 are moved individually in succession one after the other onto the freight train 28 in the longitudinal direction 20 of the train via the entry and exit ramp 29. The semi-trailers 3 are preferably pulled by the traction vehicles 21. The front, first tractor-trailer unit 30 of the series of tractor-trailer units 30 travels on the continuous driving lane formed by the low-floor railcars 10 the length of the entire freight train 18 up to the locomotive 19, stopping a predetermined distance away. The other tractor-trailer units 30 drive one after the other likewise over the continuous driving lane the remaining length of the freight train 18 until they can be placed a predetermined distance away from the front tractor-trailer unit 30.

In order to hold the self-propelled, unmanned tractor-trailer units 30 in place on the low-floor railcars 10, wedges can be placed in front of and behind the wheels 8 of the semi-trailers 3.

Alternatively or additionally, the traction vehicles 21 can expediently also be held in place on the low-floor railcars 10. For example, the traction vehicles 10 can have laterally extendable spindles or other mechanical constructions such as levers or latches that can be extended sufficiently until they strike on the interior against the two side walls 16 of the railcar and are pressed against them or move into a positive engagement with corresponding opposing parts on the railcar.

The side walls 16 or the base walls 15 of the railcar can be equipped with special stops, perforated strips or racks that allow form-fit or force-fit catching or engagement for locking the traction vehicle 21 in place.

Thereby the traction vehicles 21 are non-positively or positively locked in place horizontally in both the longitudinal direction 20 of the vehicle and perpendicular thereto. The spindles expediently engage in grooves in the side walls 16 of the railcar. Alternatively, the traction vehicles 21 and the low-floor railcars 10 have other means for locking the traction vehicles 21 in place horizontally on the low floor railcars 10, particularly by form-fitting means.

Once all tractor-trailer units 30 have been locked in place, the freight train 18 is ready to depart. The tractor-trailer units 30 are conveyed by the freight train 18 to the destination freight transfer terminal or the destination transfer rail station. There the freight train 18 is again maneuvered with one end against an entry and exit ramp 29 or an entry and exit bridge (not shown). The end of the train that lies at the front in the travel direction of the traction machines 21 is expediently chosen.

Alternatively, loading ramps present on the platform or the railcars can be folded out or swung in.

As soon as the freight train 18 has reached its final stopping position, the wedges are removed and the locking of the traction vehicles 21 in place with the low-floor railcars 21 is released. The tractor-trailer units 30 are then driven individually, successively and one after the other down from the freight train 28 over the entry and exit ramp 29 in the longitudinal direction 20 of the train, with the semi-trailers 3 being towed by the traction vehicles 21.

In the destination freight transfer terminal, the individual tractor-trailer units 30 are positioned at predetermined positions and the traction vehicles 21 are uncoupled from the semi-trailers 3. For that purpose, the support legs 7 are extended, especially by the operating personnel. Then the locking of the rotary catches of the fifth wheel coupling 24 is released. This is done, for example, manually by an operator who pulls on the unlocking handle, whereby the locking lever is actuated in such a manner that the locking of the rotary catch is released. The rotary catch then snaps back into its open position due to the spring force, so that the kingpin 6 is released.

The traction vehicle 21 then lowers the semi-trailer 3 onto the support legs 7 by lowering the trailer plate 9.

Then the respective traction vehicle 21 preferably travels forward under the trailer support surface 5 of the respective semi-trailer 3. In this process the kingpin 6 moves out of the fifth wheel coupling 24. Alternatively, the locking lever is automatically released by an appropriate control command from the control unit and the actuation of a control member.

The traction vehicles 21 are now again free for another loading process and are moved either to the next freight train 18 to be loaded or into a waiting position. After the traction vehicles 21 have been uncoupled from the semi-trailers 6, waiting manned tractors 2 are driven to the semi-trailers 6 and coupled to them in a conventional manner. The tractor-trailer units 1 are then driven to their destination.

As already explained above, the traction vehicles 21 are moved during the entire loading and unloading process either by remote control or a remote controller, or automatically or semi-automatically, or by an automated controller based on predetermined data and/or by means of data acquired by sensors and a data processing program.

In case of remote control, the traction vehicles 21 are moved by virtue of the fact that an operator controls the transmitting device correspondingly and drives the traction vehicles 21 to the tractor-trailers 3 and away from them, as well as driving the tractor-trailer units 30 up onto the freight train 18 and down again, and stops them at the predetermined positions. The actuation of the locking lever of the fifth wheel coupling 24 and the extension and retraction of the spindles for locking and detaching the locking can also be accomplished by remote control.

With the GPS-based automated control, the traction vehicles 21 are each moved to the predetermined position on the basis of GPS data that is processed by the control unit by means of a data processing program. The necessary position data, such as the position of the semi-trailers 3 to be coupled and the position of the low-floor railcars is stored in a database, for example. Markings on the ground and on the tracks of the freight transfer terminal can serve as orientation for the truck drivers and train engineers as to where they should position their vehicle or the train. The actuation of the locking lever of the fifth wheel coupling 24 and the extension and retraction of the spindles for locking and releasing the locking can also be done automatically as soon as the traction vehicle 21 has reached the respective predetermined position and this is recognized by the control unit.

For the automated controlling by means of orientation to paint markings or induction loops, the traction vehicles 21 pass the various predetermined, pre-programmed stations or positions one by one.

The traction vehicles 21 can also communicate by means of their controller units if needed, and thus guarantee the monitoring and control of the predetermined drive-up order or specified position. Communication among them can also be used to avoid accidents. The traction vehicles 21 can likewise use position measurements relative to one another for control.

It is of course also possible to combine several types of control with one another.

One advantage of the invention is firstly that the tractors 2 and their drivers are no longer conveyed on the freight train 18. This saves costs for the shipper, since the tractors 2 and the drivers can be used elsewhere or for multi-shift operation. In addition, space is saved on the low-floor railcars 21 due to the compact structure of the invented automatically movable traction vehicles 21, which have no driver's cab 4 in contrast to conventional manned tractors 2, so that more semi-trailers 3 per train can be conveyed. Furthermore, the traction vehicles 21 according to the invention have a lower weight than the conventional tractors 2, so that the transported dead weight is less. This likewise saves expense.

Due to the very high degree of automation of the loading and unloading process, additional time and costs are saved and errors are avoided.

A further advantage of the invention is the decoupling of the presence times of the tractor 2 from the stopping times of the freight trains—the truck drivers deliver the semi-trailers 3 to the respective interim parking lots and pick up the arriving semi-trailers 3 from these parking lots; they no longer need to go by loading times and train stopping times. Large savings of time and the flexibility of the delivery and pickup times are important advantages from the standpoint of the users.

Another advantage of the invention is the utilization of the traction machine 21 for other loading processes, e.g., the loading of ship ferries with semi-trailers 3 or the shunting of semi-trailers 3 in terminals for assembling trains, etc. It is also within the scope of the invention to drive the semi-trailers 2 onto the freight train 18 and down from it with only one traction vehicle 21. In this case, the traction vehicle 21 is uncoupled on the freight train 18 and driven down from the freight train 18 or carried down by means of a crane. The semi-trailers 2 are thus transported without traction vehicles 21 on the freight train 18. The unloading of the freight train 18 takes place inversely. Moreover, several traction vehicles 21 can be used.

It also lies within the scope of the invention for the traction vehicles 21 to have RFID (radio frequency identification) chips, by means of which an identification of the traction vehicles 21 and/or reporting of the traction vehicles 21 to central control means is possible, for example, when driven onto and off of the freight train 18.

1. A traction vehicle (21) for transporting semi-trailers (3), wherein the traction vehicle (21) is unmanned and self-propelled.

2. The traction vehicle according to claim 1, wherein the traction vehicle (21) has a fifth wheel coupling (24) for coupling a semi-trailer (3).

3. The traction vehicle according to claim 1, wherein the traction vehicle (21) comprises a vehicle frame (22), drive means for driving the traction vehicle (21), steering means for steering the traction vehicle (21), as well as a control unit for controlling the motion of the traction vehicle (21) and expediently a sensor unit with several sensors.

4. The traction vehicle according to claim 3, wherein the traction vehicle (21) comprises a steering gear and a steering servomotor that is expediently operated electrically or hydraulically or pneumatically, wherein the traction vehicle (21) comprises a battery or a different energy storage means, or a combination of an internal combustion engine with a generator, or a hybrid combination of energy storage devices for supplying the steering servomotor.

5. The traction vehicle according to claim 4, wherein the steering servomotor can be controlled with the control unit.

6. The traction vehicle according to claim 3, wherein the drive means comprises a drive motor as well as a gearbox for transmitting the driving torque from the drive motor to propulsion means, in particular wheels (23), wherein the drive motor is preferably configured electrically, hydraulically, pneumatically or as an internal combustion engine and is powered, for example, by means of a battery or a different energy storage device of the traction vehicle (21).

7. The traction vehicle according to claim 6, wherein the drive motor can be controlled by means of the control unit.

8. The traction vehicle according to claim 1, wherein the traction vehicle (21) comprises means with which the traction vehicle (21) can be moved under remote-control and, in particular, can be moved under radio remote control or under infrared remote control.

9. The traction vehicle according to claim 1, wherein the traction vehicle (21) comprises means with which the traction vehicle (21) can be moved under control based on GPS data.

10. The traction vehicle according to claim 1, wherein the traction vehicle (21) is structured for loading and unloading the semi-trailers (3) onto and off of a freight train (18) forming a rolling highway, wherein the freight train (18) comprises several freight cars coupled to one another to define a continuous driving lane in the longitudinal direction (20) of the train for moving the semi-trailers (3) on the freight train (18).

11. The traction vehicle according to claim 10, wherein the freight cars are low-floor railcars (10).

12. The traction vehicle according to claim 10, wherein the traction vehicle (21) comprises means for locking the traction vehicle (21) in place on a freight car, the locking means providing at least one of a force-fit and a friction-fit, the locking means operating in at least one of a horizontal direction and a vertical direction.

13. The traction vehicle according to claim 1, wherein the traction vehicle (21) is sized such that it does not project laterally or frontwards from the semi-trailer (3).

14. A tractor-trailer unit (30) comprising the traction vehicle of claim 1, and further comprising a semi-trailer (3), wherein the traction vehicle is coupled to the semi-trailer (3).

15. The tractor-trailer unit (30) according to claim 14, wherein the traction vehicle (21) is positioned to be aligned in the vertical direction underneath the semi-trailer (3).

16. A method for at least one of loading and unloading semi-trailers (3) onto and off of a freight train (18), wherein the freight train (18) comprises several freight cars coupled to one another, and a continuous driving lane in the longitudinal direction (20) of the train for moving the semi-trailers (3) on the freight train (18), and wherein the semi-trailers (3) drive onto the freight train (18) and/or off of the freight train (18) one after another in the longitudinal direction (20) of the train, and wherein the semi-trailers (3) are each driven onto the freight train (18) or driven down from the freight train (18) by means of an unmanned and self-propelled traction vehicle (21) coupled to the respective semi-trailer (3).

17. The method according to claim 16, wherein the freight cars include low floor railcars (10).

18. The method according to claim 16, further comprising the steps of:
a) parking manned tractor-trailer units (1), each with a tractor (2) and a semi-trailer (3), at respective predetermined positions in a freight transfer terminal;
b) uncoupling the semi-trailers (3) from the tractors (2);
c) moving each of the traction vehicles (21) to a respective uncoupled semi-trailer (3);
d) coupling the traction vehicles (21) to the semi-trailers (3) forming a respective unmanned self-propelled tractor-trailer unit (30);
e) driving the tractor-trailer units (30) individually and one after another onto a waiting freight train (18) in the longitudinal direction (20) of the train.

19. The method according to claim 18, further comprising the step of locking the tractor-trailer units (30) in place on the freight railcars of the freight train (18).

20. The method according to claim 18, further comprising the steps of:
a) driving the tractor-trailer units (30) individually and one after another off of the waiting freight train (18) in the longitudinal direction (20) of the train;
b) parking the tractor-trailer units (30) at respective predetermined positions in a destination freight transfer terminal;
c) uncoupling the semi-trailers (3) from the traction vehicles (21) and driving the traction vehicles (21) away from the semi-trailers (3);
d) moving manned tractors (2) to a respective uncoupled semi-trailer (3);
e) coupling the tractors (2) to the semi-trailers (3) forming a respective manned semi-trailer truck (1).

21. The method according to claim 16, wherein the traction vehicles (21) are moved under remote control, the remote control including at least one of radio remote control and infrared remote control.

22. The method according to claim 16, wherein the traction vehicles (21) are moved by means of an automated controller based on at least one of predetermined data and data acquired by sensors and by using a data processing program.

23. The method according to claim 16, wherein the traction vehicles (21) are moved under control based on GPS data.

24. The method according to claim 16, wherein the motion of the traction vehicles (21) is controlled by means of orientation relative to paint markings that are present on a floor of a freight transfer terminal and on the freight railcars.

25. The method according to claim 16, wherein the motion of the traction vehicles (21) is controlled by means of orientation to induction loops that are present on a floor of a freight transfer terminal and on the freight railcars.

26. A method for transporting semi-trailers (3) by railway (12) and transferring the semi-trailers (3) from the railway (12) to a highway and from the highway to the railway, comprising the steps of:
transferring the semi-trailers (3) in accordance with the method of claim 16, wherein the traction vehicles (21) are transported along with the semi-trailers (3) on the freight train (18).

27. A freight transfer terminal for loading and unloading semi-trailers (3) comprising:
a freight train (18), wherein the freight train (18) comprises several freight cars coupled to one another, and a continuous driving lane in the longitudinal direction (20) of the train for moving the semi-trailers (3) on the freight train (18);
at least one traction vehicle constructed according to claim 1; and
wherein the at least one traction vehicle is configured to be coupled to the semi-trailers (3) and drive the semi-trailers onto the freight train (18) and off of the freight train (18) one after another in the longitudinal direction (20) of the train.

28. The freight transfer terminal of claim 27, wherein the freight cars including low-floor railcars (10).
